(19) United States
(12) Patent Application Publication
(10) Pub. No.: US 2011/0173097 A1
(43) Pub. Date: Jul. 14, 2011

(54) CONSOLIDATING SYSTEM AND METHOD FOR CUSTOMER TRACKING OF CUSTOMER'S ON-LINE TRANSACTIONS

(76) Inventor: Charles MCKEE, Carlsbad, CA (US)

(21) Appl. No.: 12/684,404

(22) Filed: Jan. 8, 2010

(51) Int. Cl. G06F 3/048; G06Q 10/00; G06Q 30/00

(52) U.S. Cl. 705/27.1; 705/304; 715/862; 715/841; 715/764

(57) ABSTRACT

Methods and hardware systems are described to enable an online customer to easily track or find the status of his purchases or inquires from various merchandisers without having to individually recall each merchandiser-sent emails. A software tool, operating under a hardware environment, is utilized by the customer to provide “one-stop” status and tracking facilitation. From the customer's perspective, this will make it significantly easier to keep track of various on-line purchases, etc. From the merchandiser's perspective, this will provide a direct link to the customer's desktop or interface, which bypasses the need for the merchandiser to pay for third party search engine clicks, and so forth.

### FIELD

The following description relates generally to tracking of information. More particularly, aspects of the following describe systems and methods for consumer-oriented status and tracking of on-line transactions using a comprehensive tool.

### BACKGROUND

Internet purchases or online purchases of merchandise are usually prefaced by the customer searching for a desired item using a third party search engine and thereafter clicking on the provided links to arrive at the merchandiser's web store front. For each click that drives a customer to a merchandiser's website, the merchandiser must pay a set fee to the third party search engine. After the customer arrives at the merchandiser's storefront, the customer, having purchased a good(s), will typically receive an email from the merchandiser containing links or information on the status and/or tracking of the purchased goods. An example would be an email showing whether the purchased good is in stock or being processed, or the tracking number of the good(s) in transit from a national delivery service, and any web links for further information.

To later view the latest status/tracking information of the good(s), the customer must search through all his emails to find the relevant email containing the status/tracking links from the merchandiser. In many instances, the relevant email is buried under several dozens, if not hundreds of emails. Also, if the customer wishes to find the most current information for more than one or all of his purchases from different merchandisers, his searches become even more cumbersome. Typically, this becomes more trouble than it is worth and the customer will resort to going back to the merchandiser's website and “logging” in to see the status of his order. However, it is common for the customer to not remember the website's exact address and, therefore will resubmit another search query using the third party search engine, and click on the merchandiser's link to go to his account at the merchandiser's website. Each time the customer clicks on the merchandiser's link on the third party search engine, the merchandiser must pay another fee to the third party search engine, even if the customer is already registered with the merchandiser.

The above describes the current approach that all customers take for managing their on-line purchases. Obviously, it is grossly inefficient and it is known that the management of status/tracking information for multiple merchandisers from a customer's point of view is non-existent. Therefore, systems and methods for addressing these and other needs in the community are elucidated below.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, an online tracking method for displaying to a customer on the customer's platform, information for the customer's on-line transaction with a merchant using a computerized application is provided, comprising: placing an image of an object representative of the customer's on-line transaction on a customer-managed computerized interface; summarizing at least one of a transaction date, transaction reference number, and merchant identification via textual indicators proximal to the image of the object; updating information of at least one of the merchant's status and tracking of the customer's on-line transaction via a communication network; and modifying the image of the object and textual indicators according to the updated information; wherein the image of the object and the textual indicators provide an integrated visual status and tracking summary of the customer's on-line transaction with the merchant.

In another aspect, an online tracking system for displaying to a customer information for a customer's on-line transaction with a merchant using a computerized application is provided, comprising: means for generating an image of an object representative of the customer's on-line transaction; means for summarizing at least one of a transaction date, transaction reference number, and merchant identification via textual indicators proximal to the image of the object; means for updating information of at least one of the merchant's status and tracking of the customer's on-line transaction via a communication network; and means for modifying the image of the object and textual indicators according to the updated information, wherein the image of the object and the textual indicators provide an integrated visual status and tracking summary of the customer's on-line transaction with the merchant.

In another aspect, a system for concisely displaying to the customer, information for the customer's purchase of a merchant's product using a computerized application is provided, comprising: a first computer server hosting a merchant account setup module, the merchant account setup module comprising: a merchant registration module; a merchant's web link loading module; a merchant's contact information loading module; a merchant's order identifier loading module; an access module for conveying customer purchase related information from the merchant to the customer; and means for displaying on a customer hardware platform the customer purchase related information, the means for displaying comprising: means for generating an image of an object to denote the customer's purchase; means for summarizing at least one of a purchase date, the merchant's order identifier, and the merchant's contact information, via textual indicators proximal to the image of the object; means for updating information of at least one of the merchant's processing status and tracking of the purchase via the Internet; and means for modifying the image of the object and textual indicators according to the updated information, wherein the image of the object and the textual indicators provide an integrated visual status and tracking summary of the customer's purchase; and a second computer server hosting the merchant's online products, the second server operating to process purchases by the customer.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

These and other features and advantages of the disclosure will now be described with reference to the drawings of certain embodiments, which are intended to illustrate and not to limit the subject matter.

FIG. 1 is a high-level client-server-Internet diagram.

FIG. 2 depicts a hardware block diagram for the exemplary tracking tool.

FIG. 3 depicts a process flow for account setup.

FIG. 4 illustrates a sample merchant account setup.

FIG. 5 illustrates another process flow for account setup.

FIG. 6 illustrates a sample shopper account setup.

FIG. 7 depicts an exemplary process flow for deploying the exemplary tracking tool.

FIG. 8 illustrates an exemplary database interaction block diagram for the exemplary tracking tool.

FIG. 9 illustrates an exemplary database interaction block diagram for management of communication that can be controlled in support of the exemplary tracking tool.

FIGS. 10A-D illustrate various possible visual arrangements for the exemplary tracking tool.

FIG. 11 is an illustration of one possible appearance for the exemplary tracking tool.

FIG. 12 is an illustration of another possible exemplary tracking tool appearance.

FIG. 13 depicts an exemplary block diagram function of the exemplary tracking tool's source acting as an intermediary between a customer and merchant.

FIGS. 14A-C depict several different kinds of exemplary pane actions.

FIG. 15 depicts an exemplary source and database interaction block diagram for supporting a customer platform.

FIG. 16 is an illustration of another embodiment for a customer using a web browser-based platform.

FIG. 17 is an exemplary illustration of the embodiment of FIG. 16 configured for a mobile driven client.

FIG. 18 depicts one of several possible modes of operation of the exemplary tracking tool.

### DETAILED DESCRIPTION

In various embodiments described herein, software methods and hardware systems are described to enable an online customer to easily track or find the status of his transactions, or purchases, or inquires from various merchandisers without having to individually recall each merchandiser-sent emails. In various embodiments, an exemplary software tool, operating under a hardware environment, that is utilized by the customer, will provide “one-stop” status and tracking facilitation. From the customer's perspective, this will make it significantly easier to keep track of various on-line transactions, purchases, etc. From the merchandiser's perspective, this will provide a direct link to the customer's computing desktop or interface, which bypasses the need for the merchandiser to pay for third party search engine clicks, and so forth. These and other aspects will be detailed below.

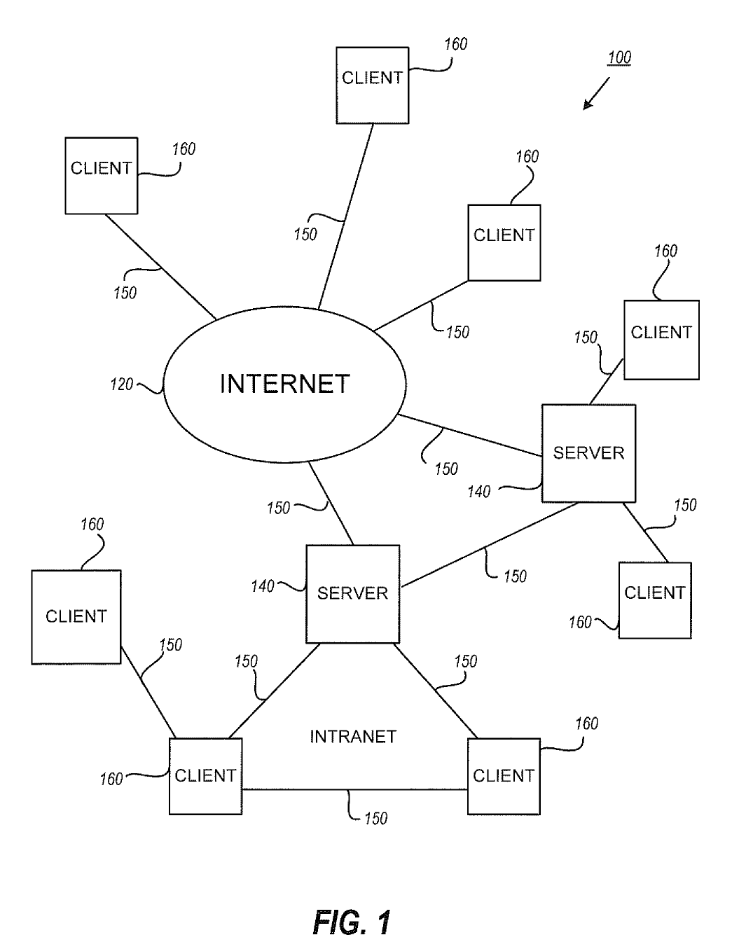

FIG. 1 is a high-level client-server-Internet diagram 100. Internet cloud 120 is connected to various servers 140 and clients 160 either directly or indirectly via connections 150. The connections 150 may be hard line or wireless or any combination thereof. The exemplary software and mechanisms may be hosted on a client machine 160, depending on design and machine capabilities. In some embodiments, servers 140 can host individually or in a distributed format, exemplary software and mechanisms for providing the features of the various embodiments discussed herein. The various servers 140 and clients 160 will be computing stations with appropriate support hardware, such as memory, processors, and so forth.

It is understood that the terms server and client are relative terms. And that depending on the capabilities of the machine providing the server/client services and/or its connectability, the machine may take the form of a telephone, laptop, net-machine, mobile phone, appliance, and so forth. Therefore, any device or machine capable of running software and communicating to another device may be considered as a client machine or, depending on the software being run, a server machine. Accordingly, FIG. 1 is understood to be a general description of a client-server Internet diagram and therefore does not describe all the possible connections, hardware and arrangements for communication/processing hardware that may be utilized. Also, while FIG. 1 is described in the context of an Internet-based topology, other topologies as well as forms of communications (other than Internet or packet-based) may be used. Therefore, modifications may be made to the features of FIG. 1 with the understanding that they are within the scope and purview of the various exemplary embodiments described herein. The overall layout shown in FIG. 1 provides a hardware basis (aka, machine) for deploying the various systems and methods described herein.

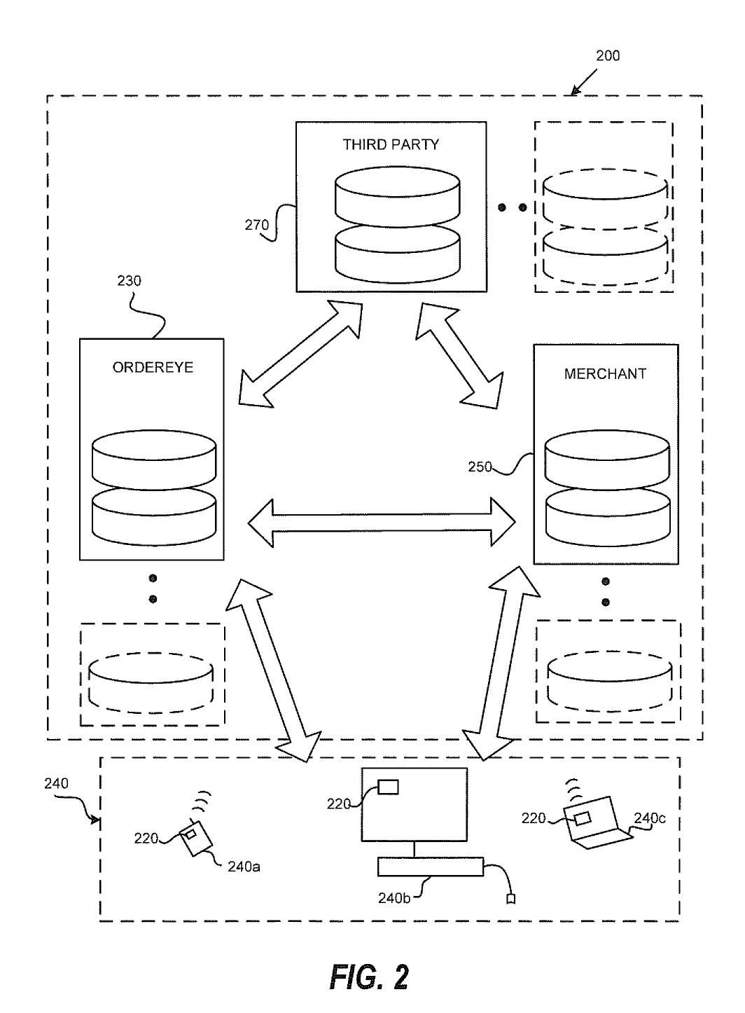

FIG. 2 depicts a hardware relationship diagram 200 for the exemplary tracking tool which is indicated, in this embodiment, as an icon 220 on various hardware platforms 240. Examples of hardware platforms 240 are shown in FIG. 2 as a mobile phone 240a, computer 240b, and/or portable computing device 240c, all of which, in some embodiments can have an imaging resource controlled by a processor, for displaying information to the user. Of course, other hardware platforms 240 may be utilized according to design. The exemplary tracking tool provides the shopper with information on his purchase by executing software procedures and/or algorithms resident on any one or more of the hardware platforms 240, as well as on Ordereye™ server(s) 230, merchant server(s) 250 and other third party server(s) 270. It is noted that Ordereye™ is a trademark of the present inventor. In various embodiments, the exemplary tracking tool may utilize one or more of servers 230, 250, and 270 for execution or information relating to the exemplary tracking tool. For example, the exemplary tracking tool may need updated information from merchant's server 250 on the state of the transaction, or item is in stock or not. Such information could be directly obtained from merchant's server 250, without communicating through the Ordereye™ server 230. However, in some instances, it may be desirable to have such information processed or obtained via Ordereye™ server 230, rather than directly from the merchant's server 250, with Ordereye™ server 230 acting as the gateway between the shopper and the merchant.

Alternatively, there may be instances where the exemplary tracking tool may need updated information on the transaction, or shipping of the purchased good(s). Such information may be obtained via third party server(s) 270, such as a shipping company, airline, hotels, tickets, etc., for example. Similarly, in some instances, it may be desirable to have such information processed or obtained via either merchant server(s) 250 and/or Ordereye™ server(s) 230, other servers, etc., depending on how information is chosen to flow between the different servers.

As one possible example, status and/or tracking information may be updated on Ordereye™ server(s) 230 on a regular basis by Ordereye™ server(s) 230 (and then sent to shoppers' hardware platform 240, when requested) or may be initiated by shopper's hardware platform 240 (e.g., upon turning on or activation of shopper's hardware platform 240 or icon 220, a request to the respective server(s) is made and information is gathered by the server(s) and then sent to shopper's hardware platform 240).

As should be apparent from the above examples, there are many different methods or approaches to providing up-to-date information to the shopper, therefore, the above examples are not to be construed as the only possible approaches applicable to the exemplary embodiments disclosed herein. As one non-limiting example, various servers and hardware/software elements of the exemplary system may be implemented using cloud computing concepts. Accordingly, it is understood that various changes and modifications may be made without departing from the overall spirit and scope of the embodiments described herein.

Regarding the variability of hardware, FIG. 2 illustrates several possible servers as supporting the functionality of the exemplary tracking tool, with additional optional servers indicated with dashed lines. It should be explicitly understood that while several servers may be utilized, in some instances only one server may actually be needed. For example, all of the information needed for dissemination to shopper's hardware platform 240 may be resident or obtained via a single server (e.g., Ordereye™ server(s) 230), the single server having access, if needed, to other information containing servers. Thus, depending on the implementation and nature of the information needed, only one server may be sufficient for disseminating information and/or operation.

Alternatively, it should be apparent that in some embodiments, any one or more of the servers shown may operate as a master-slave, controlling the access of information to and from other servers, as needed. Thus, more than two or three servers may be accessed or involved, in some instances, depending on how the information is spread out over the different servers. Thus, while FIG. 2 illustrates three servers, more or less servers may be utilized.

Depending on hardware and software considerations, the exemplary tracking tool may not be installed on shopper's hardware platform 24, but may be resident on non-shopper hardware. That is, the software processes and/or algorithms may be executed on Ordereye™ server(s) 230, with updated information forwarded to shopper's hardware platform 240 via a software hook on shopper's hardware platform 240. One example of this implementation could be in the use of Really Simple Syndication (RSS) feeds, where information shown by icon 220 may be RSS'ed—with information coming from Ordereye™'s server(s) 230. Of course, the software processes and/or algorithms may also be distributed over the various servers and, therefore, the RSS feed may obtain its information from respective servers 230, 250, and 270, as needed. As will be made more evident below, various methods and operational arrangements for the exemplary tracking tool are possible.

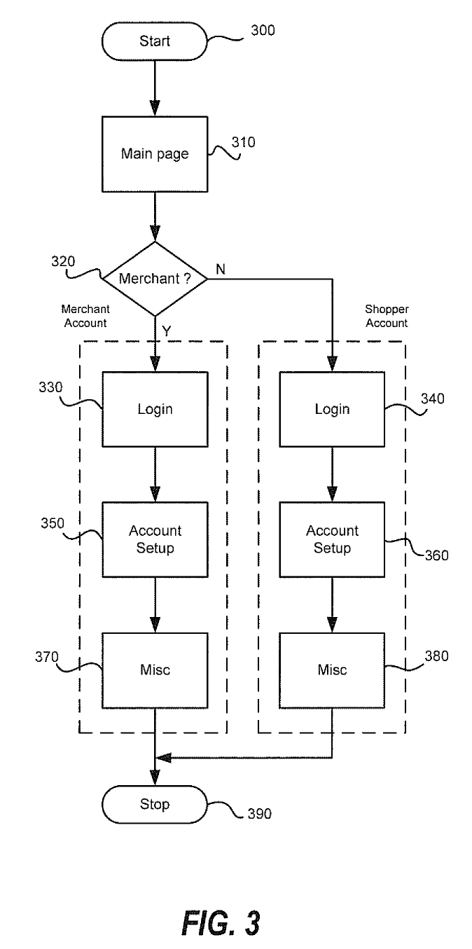

FIG. 3 depicts one process flow example for account setup for the exemplary tracking tool. Account setup can be managed for both the shopper and the merchant, if so desired, whereas the merchant can configure what features and/or information are to be forwarded to the shopper/customer (or displayed, etc. via the exemplary tracking tool), and the shopper/customer can determine what levels of information/access is enabled (or the format, etc. for the exemplary tracking tool display). In some embodiments, a minimum set of information or features will be required. In other embodiments, it may be completely configurable, or variable. The sample process flow begins 300 with entrance into main page 310 provided by the tracking tool provider. In the examples provided herein, the provider of the tracking tool or “face” of the tracking tool provider can be configured as an Ordereye™ interface.

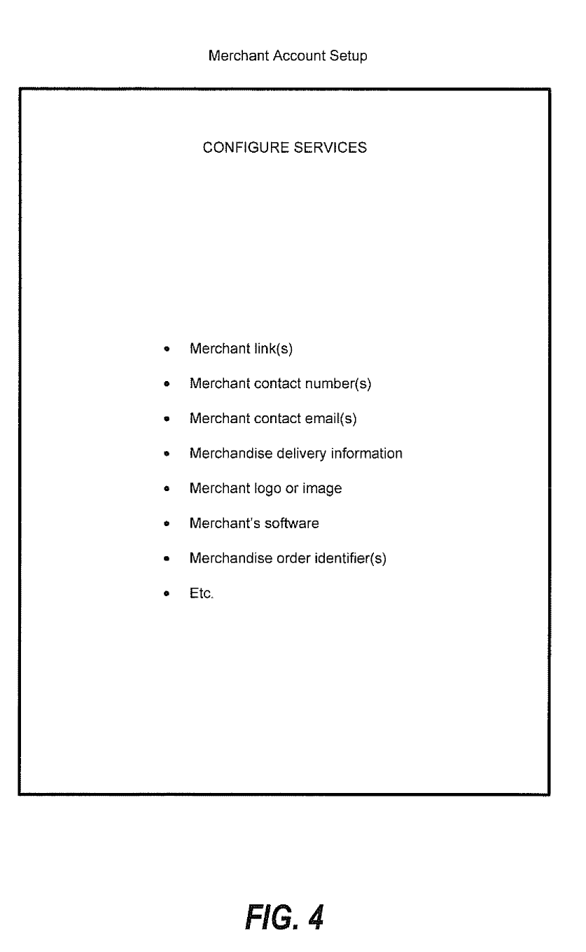

The main page 310 may simply be the home page of Ordereye™. From this main page 310, a question 320 or flow process option will be posed to the viewer—whether they are there to set up a merchant account or shopper/customer account? The viewer will select the appropriate response and then be ushered into the respective account setup channel. If the viewer selects merchant account, then the viewer will proceed onto merchant login 330, setup 350 and miscellaneous 370, where various levels of information and account setup and configuration are performed. An example of one of several possible forms of information, etc. is described in FIG. 4. After completion of the account setup, the process ends 390.

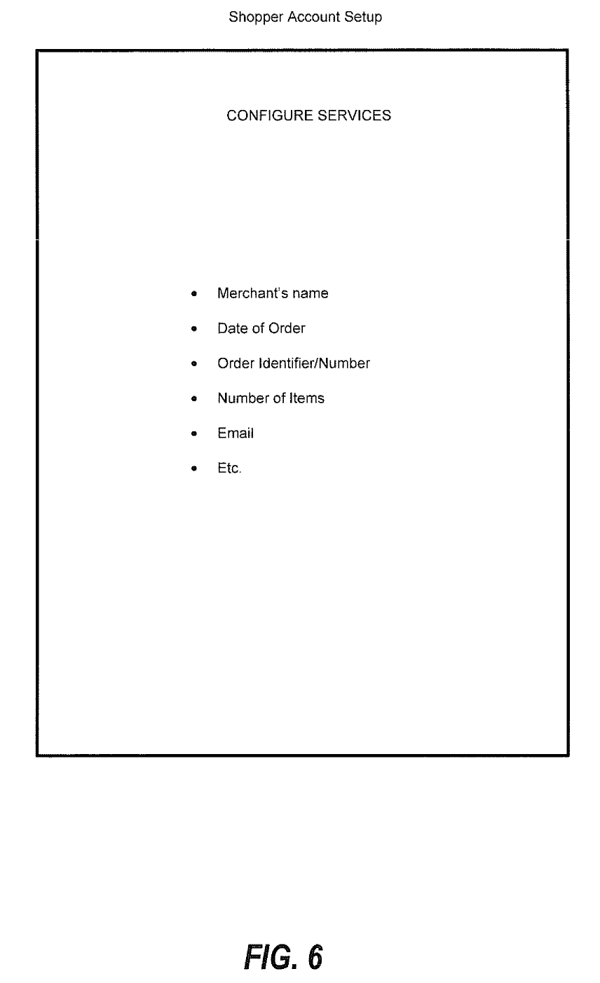

In the alternative, if the viewer selects shopper account, then the viewer will proceed into shopper login 340, setup 360 and miscellaneous 380, where various levels of information and account setup and configuration is performed. An example of one of several possible forms of information, etc. is shown in FIG. 6. After completion of the account setup, the process ends 390.

In FIG. 4, some other levels of information for merchant account setup is listed. For a first-time merchant, typical account information such as merchant name, address, accounting information, and so forth may be required. The “registration” aspects for a merchant setup are well known and, therefore, not elaborated herein. With the merchant's account being setup, configuration of the exemplary tracking tool, for the purposes of the merchant, can be as follows:

Merchant link(s)—the merchant can submit the web address or link address that the merchant wants displayed on the customer's tracking tool.

Merchant contact number(s)—this can be simply a telephone number or other contact number/information that will be provided to the customer's tracking tool.

Merchant contact email(s)—this can be the email analogy to the contact number(s) mentioned above.

Merchandise delivery information—this can be a tracking number (e.g., UPS, USPS, FedEx, etc.) that can be provided to the customer's tracking tool. Of course, other delivery information, including the shipper's invoice, name, delivery time, status, etc. can also be provided here.

Merchant logo/image—this can be an opportunity for the Merchant to place the store logo on the customer's tracking tool.

Merchant's software—embedded code or script of some sort can be placed into customer's tracking tool that allows other forms of information to be directed into the customer's tracking tool. Some non-limiting examples would be an avatar, moving image, remote link, webobject, static image, RSS feed, advertisement of a special, etc.

Merchant's order identifier(s)—this can be information such as a product name, product availability status, and so forth.

Etc.—this is a catchall section for information/items that do not fit within the categories discussed above.

It is understood that the above examples are non-limiting examples or features that a merchant may enter. Therefore, lesser or other types of information/items may be configured by the merchant. In some instances, depending on, for example, a promotion being provided to the merchant or the “account privileges” of the merchant, some of the options may be disabled or enabled. In some embodiments, some of these options may not be available or may be pre-configured. Also, in some instances a tutorial on how to set up the merchant account may be provided. Therefore, changes and modifications to the above-listed information/items may be made without departing from the spirit and scope of this disclosure.

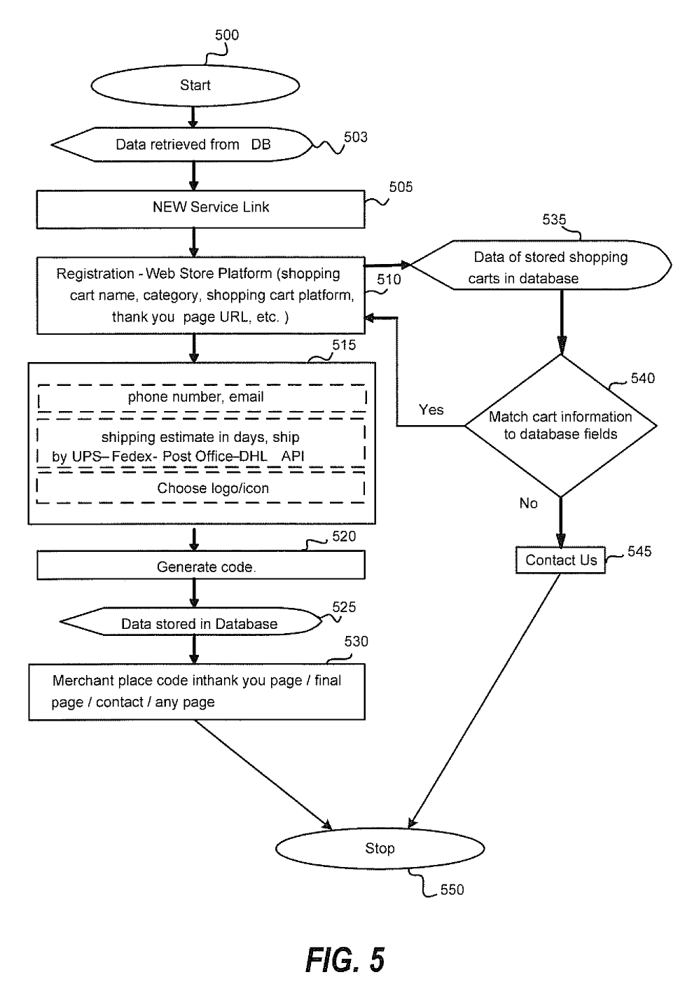

FIG. 5 depicts another exemplary process flow detailing additional features applicable in many respects to the embodiments shown in FIGS. 3-4. The exemplary process of FIG. 5 allows either a merchant access to the exemplary tracking tool for his shoppers. The exemplary process begins with an initiation 500 upon which data is retrieved from a database 503 for accommodating the exemplary process. Next, a new service link is invoked 505. In some instances, steps 503 and 505 may be combined into a single step. Next, a registration process is enacted 510 for the registering entity. Depending on the type of transaction being handled, a shopping cart segue 535 operation may be utilized, where the shopping cart data is managed. For example, in one scenario, a merchant may have shopper's information pre-configured accessible via database 535, whereas the merchant may wish to transfer or provide existing customers the capabilities of the exemplary tracking tool. If shopping cart information is available, then the exemplary process performs a sanity check 540 to determine if information in the shopping cart is consistent with information provided/available for sale by the merchant. If the shopping cart information is outdated or does not match, then the exemplary process exits out to Contact Us 545 and then to termination 550. If the shopping cart information is correct then the exemplary process updates the registration 510 to include information gathered from the shopping cart.

With registration 510, the exemplary process may request contact information from the merchant, such as the merchant's phone number, email, shipping estimates, icons, etc., as show in 515. As part of the registration 510/515, code may be generated 520 containing some aspects of the particulars of the information from the registration. The code can be copied/pasted into the merchant's website for activation or linking to the exemplary tracking tool's server(s). The ensuing data/code 520 and registration information 515 is stored into a database 525. After completion of the above steps, the exemplary process proceeds to a final checkout/thankyou page 530 and then exits 550.

FIG. 6 is the shopper analogy to the merchant account setup and is briefly described. For a first time shopper account setup, some level of shopper information may be required, such as shopper's name, email, etc. Aspects of “registration” are well known and, therefore, not elaborated herein. With (or without) registration, the shopper may have differing levels of control as to what levels of information the tracking tool will provide to the shopper. Examples of these are:

Merchant's name—the shopper can elect to have the tracking tool display the merchant's name or some other merchant identifier.

Date of order—the shopper can configure the tracking tool to include the date of order.

Order Identifier/number—a reference to the order can be enabled.

Number of items—self explanatory.

Email—the email of the merchant's may be enabled for linking to the merchant's help desk or order information desk, and so forth.

Etc.—this is a catchall section for information/items that do not fit within the categories discussed above.

As with FIG. 4-5, variations, additions, deletions, modification, and so forth may be made to the list shown in FIG. 6, without departing from the spirit and scope herein. In some instances, a tutorial on how to set up the account may be provided. It should be understood that in some embodiments, the level or scope of choices, as well as the ability to configure the shopper-side setup may be very limited or even non-existent. That is, in one embodiment, a pre-configured setup may be offered to the shopper, thus obviating the need for the shopper to “manually” configure the account for that specific merchant. As one possible example, upon purchase of an item from a merchant's website, the merchant's information may be automatically forwarded to the Ordereye™ site. Upon logging into the appropriate site for tracking tool configuration, the shopper may be offered the choice to confirm that the merchant/shopper information displayed is accurate. This approach would streamline a shopper's account setup, if so desired.

In other embodiments, the shopper may only have a set of pre-configured information provided to him, and additional information may be requested. Additionally, discounts for that merchant or related merchants could be presented to the shopper during some aspect of account setup.

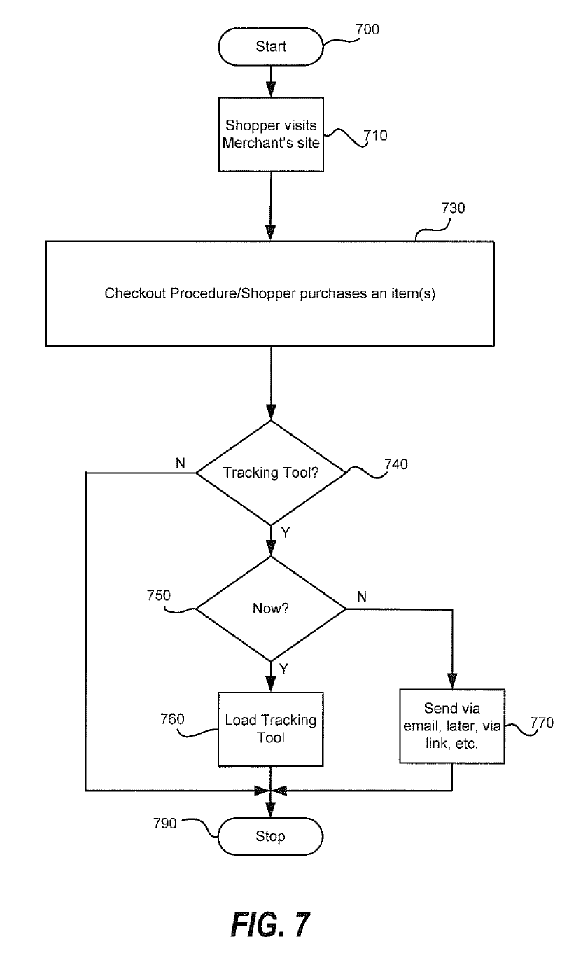

FIG. 7 depicts an exemplary process flow for deploying the exemplary tracking tool for use by the shopper. The process starts 700 with the shopper visiting 710 a merchant's site and encountering a checkout cycle 730 (or stage of purchase/reservation or transaction, etc.). In the “checkout” cycle 730, the shopper can be offered the option 740 to load or use the exemplary tracking tool. If the shopper decides not to load or use the exemplary tracking tool, the exemplary process proceeds to the end 790 and terminates. Not shown after the termination step 790 may be the merchant's typical checkout procedure where a traditional email is sent to the shopper with details of the purchase, wherein the exemplary tracking tool could be loaded as a part of the forwarded email content.

If, however, the shopper decides to load or use the exemplary tracking tool, the process can optionally query 750 the shopper if he would like the tracking tool to be loaded or used at this instance. (Obviously, the reverse could be asked—to use/load the exemplar tracking tool later). If the shopper replies yes (no), then the process proceeds appropriately to loading the tracking tool 760 (sending the tracking tool later 770) and from there proceeds to terminate at 790.

It should be understood that the tracking tool installation or access provisioning may be implemented prior to the “checkout” procedure. For example, a promotion or other benefit may be presented to the shopper before he begins perusing the merchant's website that would allow the shopper to pre-install or install the tracking tool before proceeding with shopping on the merchant's website. Other variations of when the installation procedure can be offered to the shopper during the shopper's shopping experience, according to design implementation. It should be understood that the terms install, installation, loaded, used, and so forth are terms dependent on context and mode of deployment. For example, in some embodiments, it may be desirable to have the exemplary tracking tool installed as an independent application running natively on the shopper's hardware platform. In other embodiments, the exemplary tracking tool may simply be a dependent application (from another hardware platform, for example) or a link to a resource that provides the same or equivalent level of service, and so forth. A contemporary example would be the implementation of a “widget” on the desktop. Another contemporary example would be an iphone app. Another contemporary example would be a webpage set to Ordereye™. Another example would be an integrated application loaded with an operating system, or integrated into a separate standalone application, such as, a mail managing program as Microsoft's Outlook™, etc. Thus, multiple methods and approaches to deploying the exemplary tracking tool for use are within the purview of this disclosure.

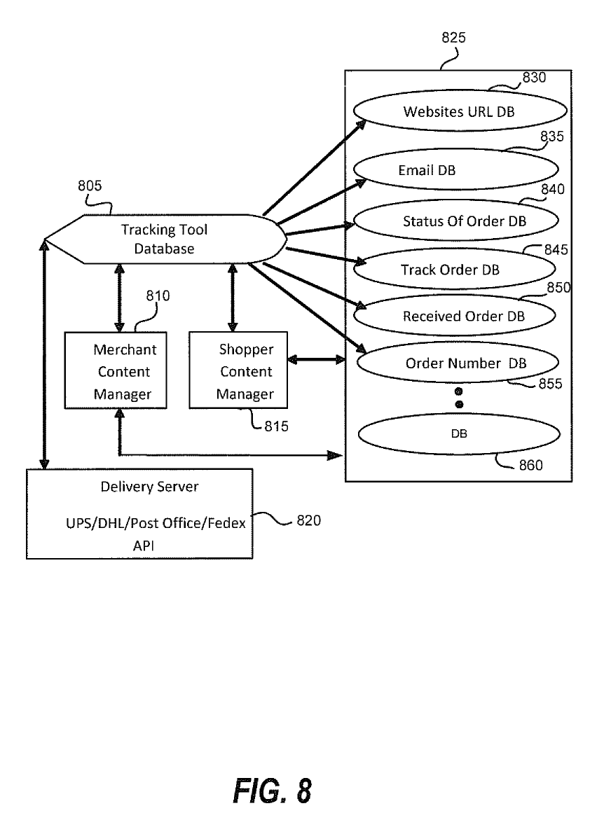

FIG. 8 is a database interaction block diagram and illustrates some of the various types of databases that can be utilized for the exemplary tracking tool. The exemplary tracking tool will have access to a database 805 that is populated or updated with information from several other databases/servers. For example, managing software for Merchant content 810 and Shopper content 815 is interfaced to the database 805. The database 805 is also interfaced with other server(s) 825 and delivery server 820. The other server(s) 825 may access several databases such as shown by 830, 835, 840, 845, 850, 855, and 860.

By interaction of these various databases and the information contained therein, the exemplary tracking tool, via its database 805, can be keep up-to-date on the status of orders or other activities in order to provide accurate information that can be forwarded to the shopper. In this example, the database 805 can operate as the central repository of information for dissemination to the shopper (and/or merchant). In some instances, database 805 may be updated periodically or updated on a need-to-know basis. The database 805 may also be managed by an internal or external program (not shown).

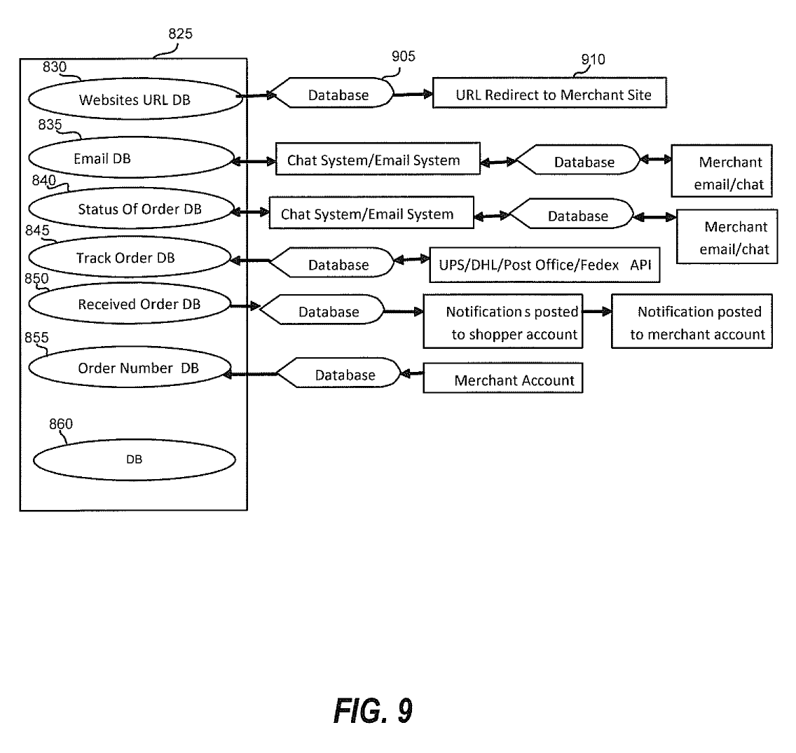

FIG. 9 is a database interaction block diagram that illustrates some of the various types of management of communication that can be controlled in support of the exemplary tracking tool. For example, sever(s) 825 containing the respective databases 830, 835, 840, 845, 850, 855, 860, etc., may pass information to merchants, shoppers, third parties (shippers, airlines, hotels, etc.) using intermediary databases and systems, as shown. As one example, website URL database 830 may be updated to indicate a change in the merchant's url address. In this event, intermediary database 905 will provide the updated URL to any queries or requests 910 that interface with the server(s) 825. Similar management through various intermediary databases are illustrated in FIG. 9, for communication that may encompass email, chat, notifications, updates, and so forth.

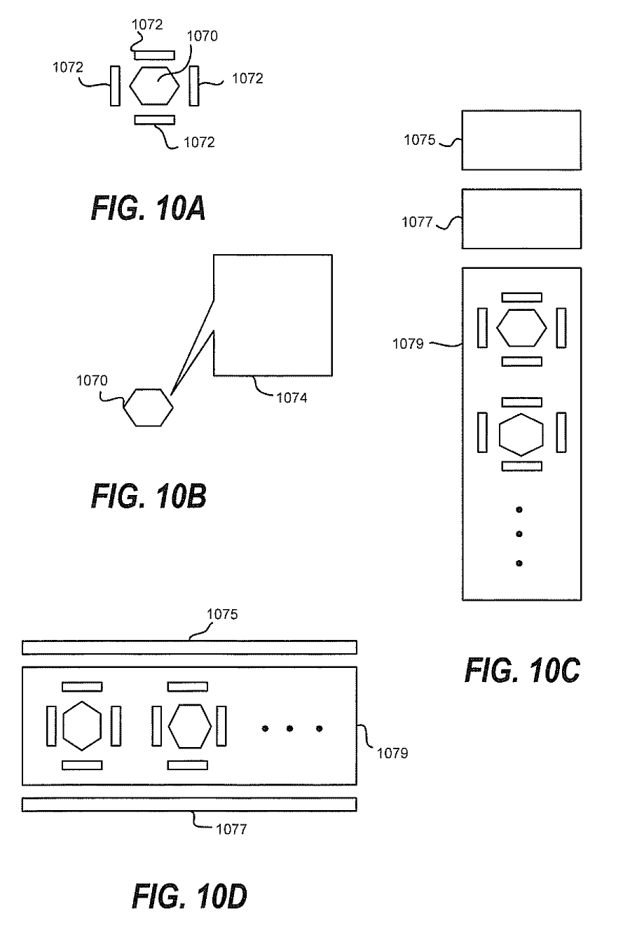

FIGS. 10A-D illustrate various possible visual arrangements for the exemplary tracking tool. FIG. 1A illustrates an icon 1070 or image or text, etc., that can be used to connote the exemplary tracking tool's presence on the shopper's hardware platform. Various shapes or forms or appearances may be used according to design implementation. As with most icons or visual indicators, some form of text or numerical information may be displayed via descriptors 1072 shown about icon 1070. The descriptors 1072 may be placed anywhere about, in, around, etc., to icon 1070 to provide additional information, as needed. For example, icon 1070 could be signified with the image of a decorative box, having possibly different text (not shown) impressed on icon 1070 and/or about icon 1070 via descriptors 1072. The color of icon 1070 or text therein, or descriptor 1072 may change according to the status of the item being monitored. Another mode for displaying the status could be the changing of the icon image from one image to another image. For example, if the tracked item is en route, icon 1070 could change to a truck or airplane or ship, etc. Other possible arrangements are shown in FIGS. 10B-D.

FIG. 10B shows an illustration where descriptors 1072 can be provided via a pane 1074, for example, a “pop up” window or other similar functionality that is triggered by mousing over icon 1070 or clicking on icon 1070, and so forth. FIG. 10C shows another arrangement where a series of icons and attendant descriptors are placed in a pane 1079. Additional information can be provided via the sections shown by 1075 and 1077. For example, a listing of all items en route may be shown in section 1075 and items not purchased but of interest in section 1077. FIG. 10D shows another arrangement where the pane 1079 is horizontally oriented with the additional information sections 1075 and 1077 also horizontally oriented. Of course, depending on design implementation, the pane 1079 and information sections 1075 and 1077 may be placed in any orientation or with any shape. Additionally, in some embodiments, a single icon 1070 may be used, with appropriate descriptor(s) 1072 control or highlight control, for displaying multiple items, if so desired.

The above FIGS. 10A-D are non-limiting demonstrations of various ways for illustrating the status or tracking of items (transactions) by the customer. A benefit of using an icon and (as needed) descriptors 1072 is that the status/tracking information can be conveyed to the customer with minimal use of hardware platform space (e.g., window, desktop, etc.). The benefits associated with using an icon to convey information and the attendant variations, modifications, manipulations, and so forth for providing that information is understood to be within in the purview of one of ordinary skill in the software arts. Therefore, all possible forms of implementations not described herein are understood to be implicit or inherent.

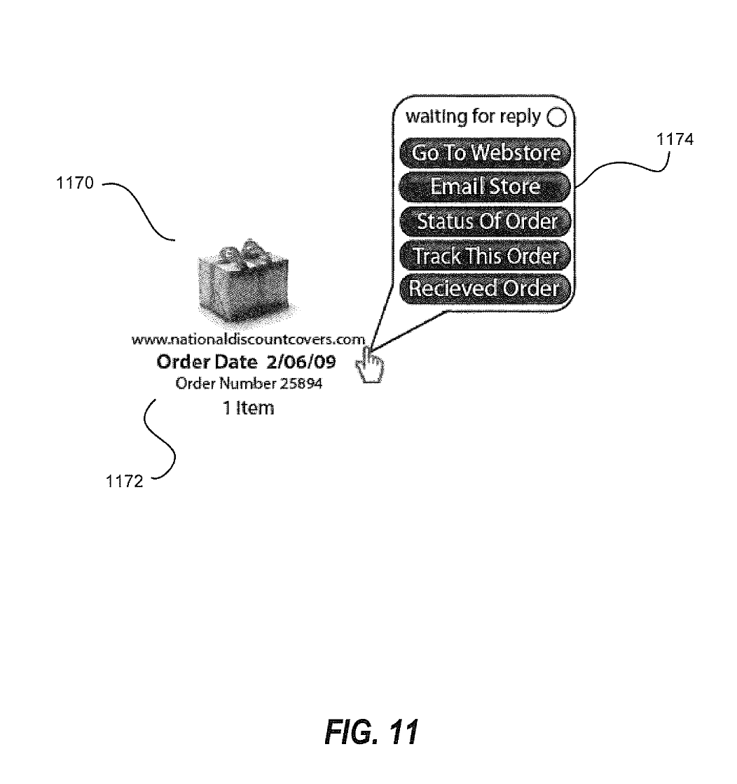

FIG. 11 is an illustration of one possible appearance for the exemplary tracking tool utilizing some of the features detailed above. For example, the icon 1170 is illustrated as a wrapped package, with descriptor(s) 1172 displaying the website that the good(s) was purchased from (www.nationaldiscountcovers.com), the order date (Feb. 6, 2009), order number (25894), and number of items (1). Also, the introduction of a pointer (signified by the “extended finger icon”) brings up a pane 1174 showing additional options and/or information to the shopper. The pane 1174 details some simple status/options (“waiting for reply”, “Go To Webstore”, “Email Store”, “Status of Order”, “Track This Order”, “Received Order”). Of course, other status indicators and/or options may be presented, accordingly to design preference.

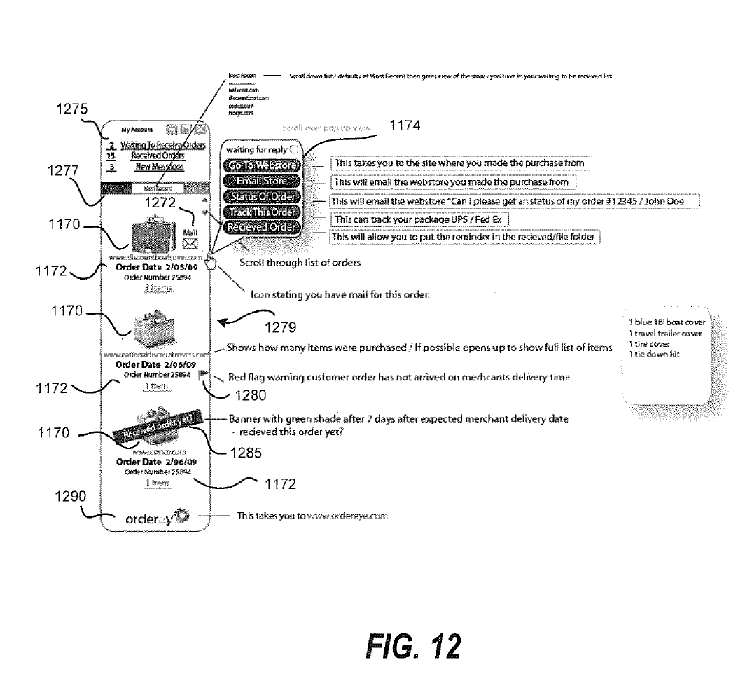

FIG. 12 is an illustration of another possible exemplary tracking tool appearance. Multiple icons 1170 and descriptors 1172 are “contained” in a larger pane 1279. It is worth noting that in the top icon, there is a “mail” indicator 1272 showing that mail is pending/not-read for the first-listed item (“New messages”). The relationship of descriptors 1172 to their icon 1170 can be a useful property, if so configured. In some exemplary embodiments, the descriptors 1172 may be locally tied to their icon 1170. In other embodiments, the descriptor may be global or arranged in non-locally tied manner. For example, descriptor 1280, as shown with a “red” flag, indicates that the delivery of a product is late. Another example is where a colored banner or marker 1285 is placed over the icon 1170, as desired. Also, descriptor 1290 can be provided to offer a convenient link to the tracking tool source website. Arrangement of icons 1170 and their descriptors 1172 are understood to be within the purview of one of ordinary skill. However, the color, shape, dynamics, etc. shown in the exemplary embodiments described herein integrate multiple sources of information into simple, very informative visual indicators to succinctly inform the shopper of the status of his transactions/purchases/reservations, and so forth.

Additional information and/or capabilities are shown via panes 1275 and 1277. For example, pane 1275 shows the overall status of orders and pane 1277 shows a sort window. As should be apparent, different forms of information or capabilities can be shown via the panes 1275 and 1277, the choices only being limited by one's imagination.

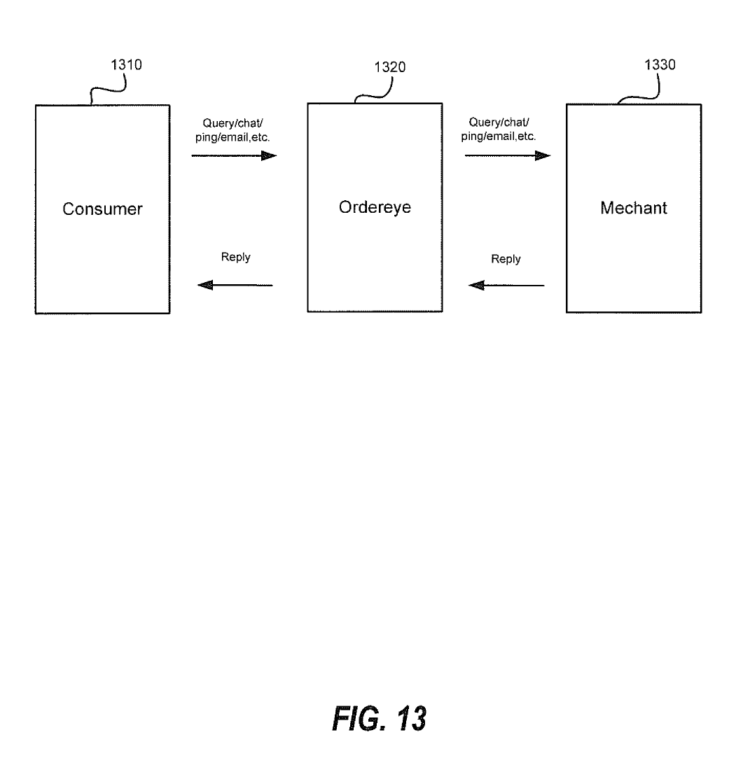

FIG. 13 depicts a block diagram function of the exemplary tracking tool's source 1320 (shown here under the inventor's Ordereye brand) acting as an intermediary between a customer 1310 and the merchant 1330. As an intermediary service, the source 1320 can coordinate messages between the customer/merchant, for example for email, chat, SMS, video, etc. That is, management of the information between the parties can be solely controlled by the tracking tool source provider 1320, if so desired.

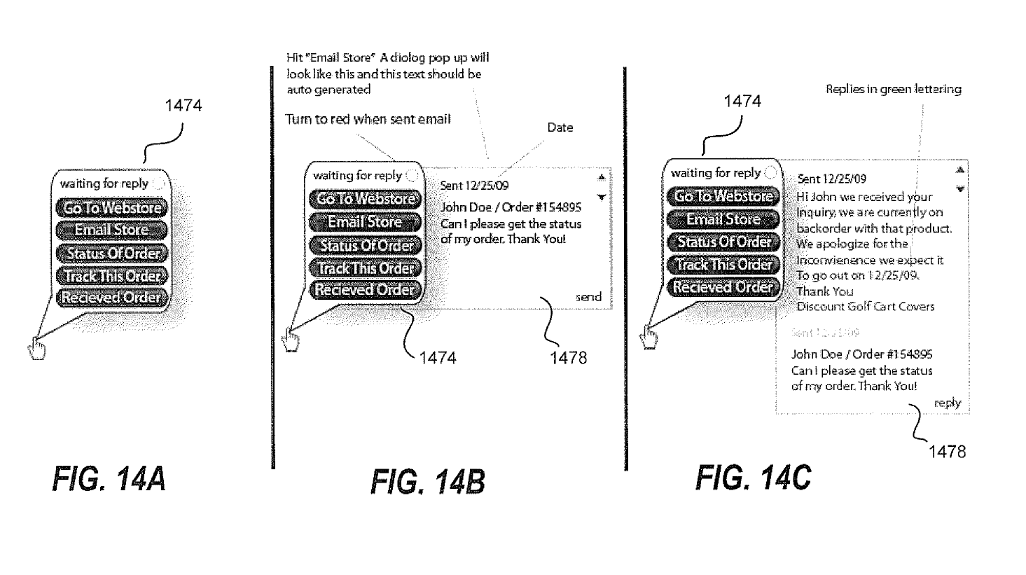

FIGS. 14A-C depict several different kinds of pane actions. FIG. 14A shows a simple pane 1474 similar to the pane 1174 shown in FIG. 12. FIG. 14B shows how an action, such as facilitating the composing of email to a merchant can be accomplished using one of the context/click sensitive areas (for example, “Email Store”) of the pane 1474 by generating a sub-pane 1478. FIG. 14B depicts another scenario where received email is also presented to the shopper in a sub-pane 1478. It should be understood that various portions of the pane 1474, and or sub-pane(s) 1478 may change color or shape, according to design preference.

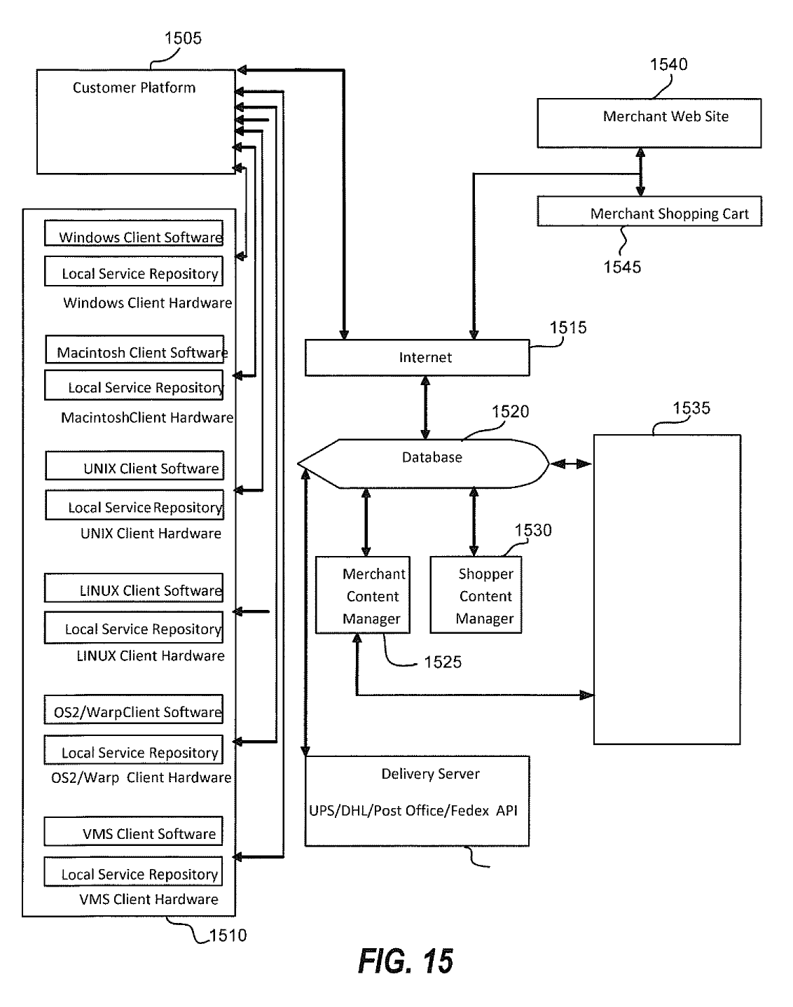

FIG. 15 depicts a source and database interaction block diagram for supporting a customer platform 1505. Specifically, in order to accommodate multiple customer 1505 platforms, the exemplary tracking tool system will have various software tools 1510 tailored for the customer's platform 1505. For example, FIG. 15 shows that Windows, Apple, Unix, Linux, OS2 and other types of operating systems and tools can be supported by a properly configured exemplary tracking tool system. It should be understood that the list of operating systems shown in FIG. 15 are only shown to demonstrate suitable examples, and should not be construed as constituting all possible operating systems. Therefore, other platform operation systems such as Android, Beos, etc., may be contemplated.

From a network 1515, the customer platform 1505 accesses the features of the exemplary tracking tool through database 1520. Database 1520 acts, in many respects, similar to the database 805 of FIG. 8. However, in addition to the capabilities that may be provided by the database of 805 of FIG. 8, the database 1520 is also directly or indirectly coupled to a Merchant's site via the network 1515 to acquire merchant site information 1540 and merchant customer/transaction information for the customer. Similarly, the database 1520 may have content managed by merchant content manager 1525 and shopper content manager 1530, as well as information being provided by database(s)/tools provided by server(s) 825.

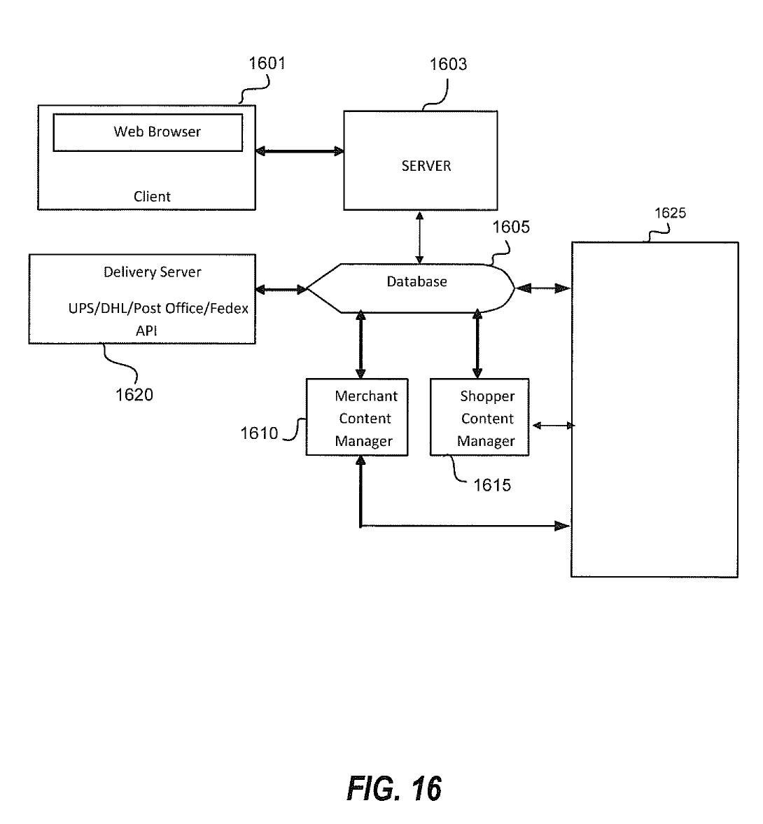

FIG. 16 is an illustration of another embodiment for a customer using a web browser-based platform 1601. The web browser-based platform 1601 accesses the tracking tool database 1605 via a server 1603 that negotiates the communication between the servers 1625, 1620 on the tracking tool side and the server(s) 1603 on the client side. Database 1605 houses the pertinent or relevant information for the web browser-based platform 1605, which is also provided in part or in whole by server(s) 1625 either directly and/or indirectly via content managers 1610 and 1615, and delivery server 1620.

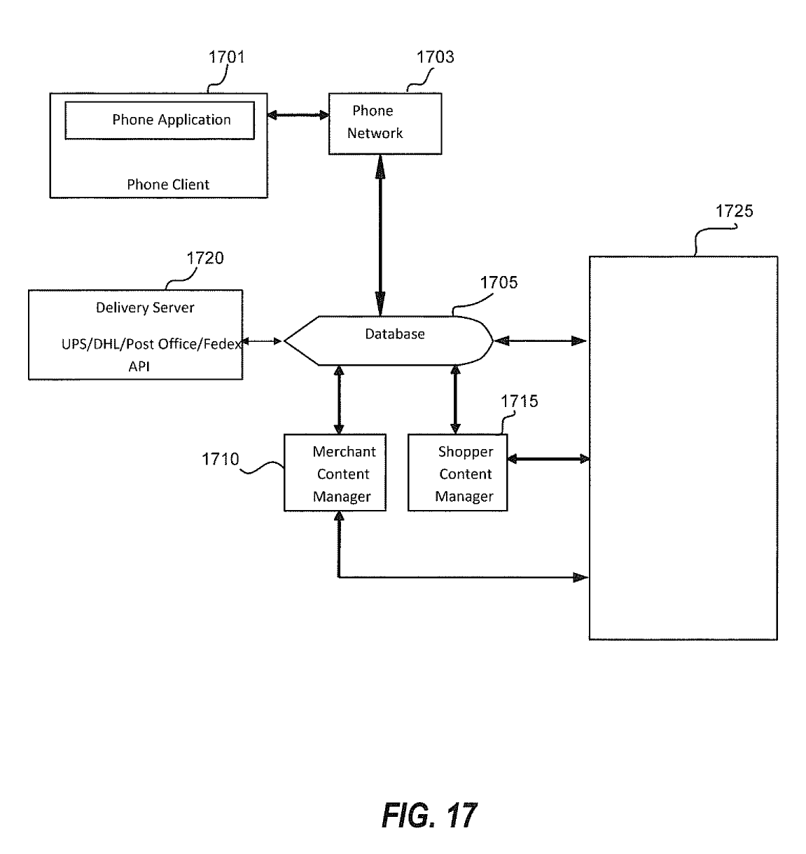

FIG. 17 is an illustration of the embodiment of FIG. 16 configured for a mobile driven client 1701. A mobile network or phone network 1702 server couples to internet network 1703 to access the exemplary database 1705 which is updated with information to and from server(s) 1725 directly and/or indirectly via content managers 1710 and 1715, and delivery server 1720.

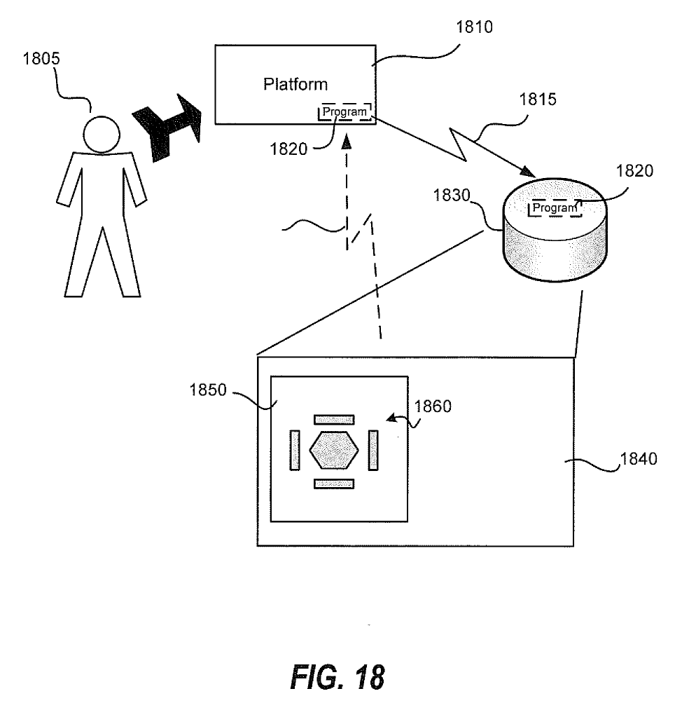

FIG. 18 depicts one of several possible modes of operation of the exemplary tracking tool. Shopper 1805 the exemplary tracking tool website via a browser or application, etc., on hardware platform 1810, running native and/or non-native code. The hardware platform 1810 may simply be kiosk running a web-based browser, if so desired. A program or link 1820 accessible from the hardware platform 1810 is serviced or hosted by a server/database 1830 via communication link 1815. The server/database 1830 may, in some instances, be the instant hardware platform 1810, depending on implementation preference.

The shopper 1805 invokes the program or link 1820 which may be completely resident on the shopper's hardware platform 1810 or resident (in part or in whole-shown as dashed lined 1820) on the server/database 1830. Invocation provides access to information available on the server/database 1830 to facilitate the controlling of a web browser, link to a widget, program client, web object, and so forth depending on the type of tool provided to the shopper 1805 on hardware platform 1810. The invoked program 1820 is updated with the most current information that pertains to the shopper's transaction, from other server(s) 1835, such as by merchants' servers and/or OrderEye™ server(s) and/or third party server(s), and may also reveal itself via communication link 1815 or by separate communication link 1875 to the shopper 1805 in a window or panel 1840, having a sub-window or sub-panel 1850, with icon(s) and descriptor(s) 8160. The window or panel 1840, and sub-window or sub-panel 1850 may be present itself to the shopper 1805 as a browser, a widget, window, or any form of graphical interface that is capable of conveying information to the shopper 1805.

Having understood the above description, it is understood that one of ordinary skill in the art of software would be able to readily create the useful and productive customer order tracking tool(s) and method(s) described, using various software approaches, languages, productivity tools, scripts, and so forth, that are well known in the art. As one example of a variation of the principles described herein, the exemplary tracking tool may be instantiated from the operating system of a consumer's device, using an integrated application, linking in information to and from an operating system specific tool. The integrated application may be something akin to Microsoft's Outlook, or a bundled feature or added capability that is tightly integrated to the operating system. Along the same lines, another application such as a web browser may be configured with the exemplary tracking tool as an add-on, extension, plug-in, or another type of integration

To date, there is no known software appliance or computer-operable program that is capable of presenting the status of an order (or transaction), in concert with merchant information, in a combined graphical image/descriptor format, that is easily referenceable by the customer, etc., as described herein. Additionally, there is no known enterprise that has contemplated (prior to this disclosure) the concept of organizing merchant selling/purchasing information into a pane of icons, as shown in some embodiments, as a “one-stop-shop” tool on a computerized device. Thus, a significant utility is provided by transforming information and data, that prior to this disclosure would have been a half dozen or more emails with embedded links from a half dozen or more merchants—lost in the cluttered “inbox” of the shopper's mail application, regarding various transactions into a unified tool that provides a concise and detailed visual status and/or tracking assessment of the entire range of transactions by the shopper. As such, the above described embodiments and related aspects present a paradigm shift in how on-line transactions can be easily referenced for status and tracking information, via dynamic icons.

In view of the above, it is also readily apparent that while the exemplary embodiments are described in the context of shopping and on-line purchases, other uses or mechanisms for attaining efficiency may be contemplated, that are not in the shopping or on-line purchasing realm. For example, online transactions such as reservations or non-physical purchases can also be “tracked” or their “status” updated by the exemplary methods and systems described herein. The status of transfers of money from a bank could be visually conveyed, and so forth, which do not entail the purchase of a good or product from a merchant. Accordingly, the term merchant is understood to be broader than someone who sells a physical item.

Aspects of the claimed subject matter may be implemented as a method, apparatus, or article of manufacture using standard programming and/or engineering techniques to produce software, firmware, hardware, or any combination thereof to control a computer or computing components to implement various aspects of the claimed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Various storage media may be integral to the computing hardware, or removable, as noted above. Of course, those skilled in the art will recognize many modifications may be made to this configuration without departing from the scope or spirit of what is described herein.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An online tracking method for displaying to a customer on the customer's platform, information for the customer's on-line transaction with a merchant using a computerized application, comprising:
placing an image of an object representative of the customer's on-line transaction on a customer-managed computerized interface;
summarizing at least one of a transaction date, transaction reference number, and merchant identification via textual indicators proximal to the image of the object;
updating information of at least one of the merchant's status and tracking of the customer's on-line transaction via a communication network; and
modifying the image of the object and textual indicators according to the updated information;
wherein the image of the object and the textual indicators provide an integrated visual status and tracking summary of the customer's on-line transaction with the merchant.

2. The method of claim 1, further comprising, displaying the image of the object and the textual indicators to the customer on a processor-controlled display containing the customer-managed computerized interface.

3. The method of claim 2, further comprising generating up a pop-up window containing clickable actions, when the customer moves a pointer over a designated area of at least one of the displayed image of the object and the textual indicators.

4. The method of claim 1, wherein the summarizing includes a quantity of items purchased from the merchant.

5. The method of claim 1, wherein the merchant identification is the merchant's URL.

6. The method of claim 1, further comprising, a collapsible pane surrounding a displayed instantiation of the computerized application.

7. The method of claim 6, wherein information for a plurality of merchants is displayed on the collapsible pane.

8. The method claim 6, further comprising an all-merchants-summary at an extremity of the pane.

9. The method of claim 1, wherein the image connotes the merchant's currently known status of the customer's on-line transaction.

10. The method of claim 1, wherein the image of the object is of a wrapped package.

11. The method of claim 1, further comprising, generating an e-mail indicator icon if there is an e-mail from the merchant to the customer.

12. The method of claim 1, wherein the customer's online transaction is a purchase obtained from the merchant.

13. The method of claim 12, wherein the image is modified to another image if the purchase has been shipped.

14. The method of claim 1, wherein the image of the object is configurable by the merchant.

15. The method of claim 1, wherein the textual indicators are configurable by the merchant.

16. The method of claim 1, further comprising, registering the merchant through a merchant account setup through a hosting site.

17. The method of claim 16, wherein the merchant account setup includes loading a merchant logo.

18. The method of claim 1, further comprising, registering the customer through a customer account setup through a hosting site.

19. The method of claim 1, further comprising, downloading a software application containing steps for the online tracking method on a customer's platform desktop.

20. The method of claim 19, wherein the downloading is preformed from the merchant's website.

21. The method of claim 19, wherein the downloading is performed within the merchant's online checkout process.

22. The method of claim 19, wherein the downloading is initiated from a link provided by an email sent by the merchant to the customer.

23. The method of claim 1, further comprising, generating a web browser window containing steps for the online tracking method on the customer-managed computerized interface.

24. The method of claim 1, wherein at least one of the merchant's processing status and tracking is obtained from a non-merchant server.

25. The method of claim 1, wherein the computerized application is instantiated from an operating system of the customer's platform.

26. An online tracking system for displaying to a customer information for a customer's on-line transaction with a merchant using a computerized application, comprising:
means for generating an image of an object representative of the customer's on-line transaction;
means for summarizing at least one of a transaction date, transaction reference number, and merchant identification via textual indicators proximal to the image of the object;
means for updating information of at least one of the merchant's status and tracking of the customer's on-line transaction via a communication network; and
means for modifying the image of the object and textual indicators according to the updated information,
wherein the image of the object and the textual indicators provide an integrated visual status and tracking summary of the customer's on-line transaction with the merchant.

27. The system of claim 26, further comprising, means for displaying the image of the object and the textual indicators to the customer on a processor-controlled display.

28. The system of claim 26, further comprising, means for generating up a pop-up window containing clickable actions, when the customer moves a pointer over a designated area of at least one of the displayed image of the object and the textual indicators.

29. The system of claim 26, further comprising, a collapsible pane surrounding a displayed instantiation of the computerized application.

30. The system of claim 29 wherein information for a plurality of merchants is displayed on the collapsible pane.

31. The system of claim 26, wherein the image references the merchant's currently known processing status of the customer's on-line transaction.

32. The system of claim 26, wherein the customer's on-line transaction is a purchase from the merchant.

33. The system of claim 26, wherein the computerized application is instantiated from an operating system of the customer's platform.

34. A system for concisely displaying to the customer, information for the customer's purchase of a merchant's product using a computerized application, comprising:
a first computer server hosting a merchant account setup module, the merchant account setup module comprising:
a merchant registration module;
a merchant's web link loading module;
a merchant's contact information loading module;
a merchant's order identifier loading module;
an access module for conveying customer purchase related information from the merchant to the customer; and
means for displaying on a customer hardware platform the customer purchase related information, the means for displaying comprising:
means for generating an image of an object to denote the customer's purchase;
means for summarizing at least one of a purchase date, the merchant's order identifier, and the merchant's contact information, via textual indicators proximal to the image of the object;
means for updating information of at least one of the merchant's processing status and tracking of the purchase via the Internet; and
means for modifying the image of the object and textual indicators according to the updated information,
wherein the image of the object and the textual indicators provide an integrated visual status and tracking summary of the customer's purchase; and
a second computer server hosting the merchant's online products, the second server operating to process purchases by the customer.

35. The system of claim 32, further comprising, a third computer server operated by a shipping entity, wherein the information of the tracking of the purchase is resident on the third computer.
